(19) United States
(12) Patent Application Publication
(10) Pub. No.: US 2018/0265283 A1
(43) Pub. Date: Sep. 20, 2018

(54) Method of Using VOC as Oil Tank Blanket Gas

(71) Applicant: Babcock IP Management (Number One) Limited, London (GB)

(72) Inventor: Nik Felbab, London (GB)

(21) Appl. No.: 15/779,138

(22) PCT Filed: Nov. 25, 2016
(86) PCT No.: PCT/GB2016/053708

§ 371 Date: May 25, 2018

(30) Foreign Application Priority Data
Nov. 27, 2015 (GB) 1520951.3

(51) Int. Cl. B65D 88/54; B01D 53/00; B01D 5/00; B65D 88/78; C10G 5/06; B63B 27/24

(52) U.S. Cl. CPC B65D 88/54; B01D 53/002; B63B 27/24; B65D 88/78; C10G 5/06; B01D 5/0075

(57) ABSTRACT

The present invention relates to the use of compressed volatile organic compounds wholly or partly as a source of blanket gas for use in oil storage tanks, and methods and apparatus of providing same This includes a method of recovering and using VOC from one or more oil storage tanks comprising recovering, compressing and separating VOC from an oil storage tank, compressing the separated uncondensed VOC to provide a compressed VOC stream, and then heating and reducing at least a portion of the compressed VOC stream to provide a decompressed VOC stream for use as blanket gas in an oil storage tank. The present invention is able to prevent or substantially reduce reabsorption of captured VOC into stored oil. This also requires less (and possibly no) addition of extra inert gas during the oil discharge, and the next oil loading into the oil storage tank starts with a tank atmosphere that is very high in hydrocarbon content, thereby preventing formation of additional VOC during the next oil loading.

The present invention relates to improvements relating to oil storage tanks, in particular the use of compressed volatile organic compounds wholly or partly as a source of blanket gas for use in oil storage tanks, and methods and apparatus of providing same

When a crude oil storage tank (on land, on a ship, or an offshore installation) is loaded with crude oil, vapour in the tank is displaced from the tank. Depending on initial conditions in the tank (such as pressure, temperature, and vapour composition), additional vapour may also be generated. This combined displaced and generated vapour is removed from the crude oil tank in order to keep the tank pressure within design limits.

This vapour is typically a mixture of inert gas and volatile organic compounds (hereinafter ‘VOC’), typically hydrocarbons, which pose an environmental problem if they are released into the atmosphere, and also represent a potential loss of product or cargo.

Currently, these displaced and generated vapours are either burned, to minimise hydrocarbon release, or partly recovered by pressurisation and condensation as ‘liquefied VOC’ (hereinafter ‘LVOC’), or some combination thereof. LVOC is a mixture of the hydrocarbons from the displaced and generated vapour, typically propane and heavier. There will generally be a fraction of the vapour that cannot bet condensed at the pressures and temperatures used to create the LVOC.

After the LVOC has been recovered, it can be used elsewhere (for example as fuel), or alternatively, it can be re-vaporised and reused as blanket gas upon a subsequent discharge of crude oil from the tank. This has the advantage of keeping a higher hydrocarbon concentration in the tank vapour space, thereby reducing generation of additional VOCs from the next oil loading. But if only part of the vapour was recovered as LVOC, there will be insufficient LVOC to fill the whole crude oil tank volume. Additionally, some LVOC may still be absorbed into the crude oil.

Both these factors will also lead to a deficit of LVOC-sourced blanket gas, the remainder of which must be made up with inert gas. The more inert gas that is introduced, the lower the benefits of reusing LVOC as blanket gas.

Thus, there is a need in the art to improve oil storage tank conditions.

### SUMMARY OF THE INVENTION

The present invention relates to compressed volatile organic compounds (VOC) as a source of blanket gas for use in an oil storage tank.

Optionally, the compressed VOC is wholly or substantially provided from a source of VOC provided by one or more oil storage tanks, optionally including one or more oil storage tanks using the blanket gas.

Optionally, the compressed VOC wholly or substantially comprises uncondensed VOC provided by one or more oil storage tanks.

Optionally, the compressed VOC partly comprises vapour of condensed VOC provided by one or more oil storage tanks.

Optionally, the compressed VOC is from a source of condensed and separated VOC provided by one or oil storage tanks, optionally including one or more oil storage tanks using the blanket gas.

Optionally, the compressed VOC is stored in a compressed VOC tank.

Optionally the oil storage tank is one of the group comprising: a cargo tank of a sea vessel including a crude oil carrier; an oil storage tank on an offshore installation including an oil platform, a floating storage and offloading (FSO) unit, a floating production storage and offloading (FPSO) unit, or an oil storage tank in land-based oil processing facility.

The present invention also provides use of compressed volatile organic compounds (VOC) as a source of blanket gas in an oil storage tank.

Optionally, the compressed VOC used as the source as defined herein. For example, the compressed VOC is wholly or substantially provided from a source of VOC provided by one or more oil storage tanks, optionally including one or more oil storage tanks using the blanket gas. Optionally, the compressed VOC wholly or substantially comprises uncondensed VOC provided by one or more oil storage tanks.

The present invention also provides blanket gas for use in an oil storage tank partly, substantially of wholly based on compressed volatile organic compounds (VOC).

Optionally, the blanket gas is partly, substantially of wholly based on compressed VOC and liquefied volatile organic compounds (LVOC).

Optionally, the compressed VOC to be used in the blanket is as defined herein.

The present invention provides a method of providing blanket gas for use in one or more oil storage tanks comprising at least the steps of;

(a) providing a supply of compressed VOC;
(b) heating the compressed VOC;
(c) reducing the pressure of the compressed VOC; and
(d) providing the decompressed VOC to the one or more oil storage tanks.

Optionally, the compressed VOC is supplied from a separate source, i.e. a source separate from one or more oil tanks providing VOC to be compressed as the supply of compressed VOC.

Optionally, the method further comprises the steps of:

(e) recovering VOC from one or more oil storage tanks as a recovered VOC stream;
(f) compressing and separating the recovered VOC stream to provide at least a LVOC stream and an uncondensed VOC stream;
(g) compressing the uncondensed VOC stream to provide the compressed VOC.

Optionally, the method further comprises the step of recovering the VOC from the same one or more oil storage tanks subsequently provided with the decompressed VOC.

Optionally, the method comprises compressing the recovered VOC stream to provide at least a LVOC stream and a uncondensed VOC stream at pressure above 5 barg, for example in the range 10-25 barg, and with cooling below 40° C., such as in the range 5-37° C., to provide a condensation or condensed liquid.

Optionally, the cooling is provided by one or more heat exchanges with one or more cooling streams or fluids, such as water, for example seawater, or air.

Optionally one or more of the oil storage tanks providing the recovered VOC stream comprises one or more of the oil storage tanks be provided with the blanket gas.

The present invention also provides apparatus for providing blanket gas for use in an oil storage tank, the apparatus comprising a supply of compressed VOC, a heater to heat the compressed VOC, and a pressure-reducing system to reduce the pressure of the compressed VOC.

The present invention also provides a method of recovering and using VOC from one or more oil storage tanks comprising at least the steps of;

(a) recovering VOC from the one or more oil storage tanks as a recovered VOC stream;
(b) compressing the recovered VOC stream to provide a compressed recovered VOC stream;
(c) separating the compressed recovered VOC stream to provide at least a LVOC stream and an uncondensed VOC stream;
(d) compressing the uncondensed VOC stream to provide a compressed VOC stream;
(e) heating at least a portion of the compressed VOC stream to provide a warmer compressed VOC stream;
(f) reducing the pressure of the warmer compressed VOC to provide a decompressed VOC stream; and
(g) providing the decompressed VOC stream as blanket gas to one or more oil storage tanks.

Optionally, the recovery of VOC from the one or more oil storage tanks occurs when the oil storage tank is being loaded with oil, and the providing of the decompressed VOC stream as a blanket gas occurs when the oil storage tank is being emptied of the oil.

Optionally, the method further comprises the steps of heating at least a portion of the LVOC stream to provide a warmer LVOC stream, reducing the pressure of the warmer LVOC stream to provide a decompressed VOC stream, and providing the decompressed VOC stream as additional blanket gas to one or more oil storage tanks.

The present invention also provides apparatus for recovering and using VOC from one or more oil storage tanks comprising at least;

(a) one or more pipelines able to recover VOC from the one or more oil storage tanks as a recovered VOC stream;
(b) one or more first compressors able to compress the recovered VOC stream to provide a compressed recovered VOC stream;
(c) one or more separators able to separate the compressed recovered VOC stream to provide at least a LVOC stream and an uncondensed VOC stream;
(d) one or more second compressors able to compress the uncondensed VOC stream to provide a compressed VOC stream;
(e) one or more heaters able to heat at least a portion of the compressed VOC stream to provide a warmer compressed VOC stream;
(f) one or more reducers able to reduce the pressure of the warmer compressed VOC to provide a decompressed VOC stream; and
(g) one or more pipelines able to provide the decompressed VOC stream as blanket gas to one or more oil storage tanks.

Optionally, the apparatus further comprises one or more storage tanks able to store the compressed VOC stream prior to step (e).

Optionally, the apparatus further comprises one or more storage tanks able to store the LVOC stream.

Optionally, the apparatus further comprises one or more one or more heaters able to heat at least a portion of the LVOC stream to provide a warmer LVOC stream, and one or more reducers able to reduce the pressure of the warmer LVOC to provide a decompressed VOC stream, and one or more pipelines able to provide the decompressed VOC stream as additional blanket gas to the one or more oil storage tanks.

Optionally, the apparatus further comprises one or more one or more pipelines able to provide a supply of inert gas as blanket gas to the one or more oil storage tanks.

Optionally, the apparatus is arranged on a sea vessel, on an oil platform, on a floating storage and offloading (FSO) unit, or on floating production storage and offloading (FPSO) unit.

The present invention provides a method of loading and unloading an oil or oil product, including crude oil, into and from one or more oil storage tanks comprising at least the steps of;

(a) loading the oil or oil product into the one or more oil storage tanks;
(b) recovering VOC from the one or more oil storage tanks as a recovered VOC stream;
(c) compressing the recovered VOC stream to provide a compressed recovered VOC stream;
(d) separating the compressed recovered VOC stream to provide at least a LVOC stream and an uncondensed VOC stream;
(e) storing the LVOC stream in one or more LVOC storage tanks;
(f) compressing the uncondensed VOC stream to provide a compressed VOC stream;
(g) storing the compressed VOC in one or more compressed VOC storage tanks;
(h) unloading the oil or oil product from the one or more oil storage tanks
(i) heating at least a portion of the compressed VOC stream to provide a warmer compressed VOC stream;
(j) reducing the pressure of the warmer compressed VOC to provide a decompressed VOC stream; and
(k) providing the decompressed VOC stream as blanket gas to one or more oil storage tanks.

Optionally, the method further comprises the steps of heating at least a portion of the LVOC stream to provide a warmer LVOC stream, reducing the pressure of the warmer LVOC stream to provide a decompressed VOC stream, and providing the decompressed VOC stream as additional blanket gas to the one or more oil storage tanks.

Optionally, the methods of the present invention are carried out on a vessel, such as a crude oil carrier, or on an offshore installation such as an oil platforms, or on a floating storage and offloading (FSO) unit, or on floating production storage and offloading (FPSO) unit.

Optionally, the oil storage tank in the methods of the present invention is one of the group comprising: a cargo tank of a sea vessel including a crude oil carrier; an oil storage tank on an offshore installation including an oil platform, a floating storage and offloading (FSO) unit, a floating production storage and offloading (FPSO) unit, or an oil storage tank in land-based oil processing facility.

The present invention provides a method of reducing or preventing the reabsorption of blanket gas into oil in an oil storage tank, comprising the step of using compressed VOC as a source of the blanket gas in the oil storage tank.

The present invention provides a method of reducing the creation of VOC from oil in an oil storage tank, comprising the step of using compressed VOC as a source of the blanket gas in the oil storage tank.

The present invention provides a method of reducing the use of inert gas as a blanket gas in an oil storage tank, comprising the step of using compressed VOC as a source of the blanket gas in the oil storage tank.

The present invention provides a VOC recovery plant including the use of compressed VOC as a source of blanket gas in an oil storage tank.

The present invention provides a method of integratively designing a vessel having at least one oil storage tank, comprising the steps of:

selecting one or more oil tanks for use within vessel;
selecting a first pipeline for recovering VOC from the one or more oil storage tanks as a recovered VOC stream;
selecting one or more compressors for compressing the recovered VOC stream to provide a compressed recovered VOC stream;
selecting a separator for separating the compressed recovered VOC stream to provide at least a LVOC stream and an uncondensed VOC stream
selecting one or more compressors for compressing the uncondensed VOC stream to provide a compressed VOC stream;
selecting one or more heaters for heating at least a portion of the compressed VOC stream to provide a warmer compressed VOC stream;
selecting one or more pressure reducers to reduce the pressure of the warmer compressed VOC to provide a decompressed VOC stream; and
selecting a second pipeline to provide the decompressed VOC stream to one or more oil storage tanks.

The present invention provides a method of designing an interactive use of compressed VOC as a source of blanket gas in an oil storage tank on a vessel, comprising the steps of:

designing a vessel, including
selecting one or more oil tanks for use within vessel;
selecting a first pipeline for recovering VOC from the one or more oil storage tanks as a recovered VOC stream;
selecting one or more compressors for compressing the recovered VOC stream to provide a compressed recovered VOC stream;
selecting a separator for separating the compressed recovered VOC stream to provide at least a LVOC stream and an uncondensed VOC stream
selecting one or more compressors for compressing the uncondensed VOC stream to provide a compressed VOC stream;
selecting one or more heaters for heating at least a portion of the compressed VOC stream to provide a warmer compressed VOC stream;
selecting one or more pressure reducers to reduce the pressure of the warmer compressed VOC to provide a decompressed VOC stream; and
selecting a second pipeline to provide the decompressed VOC stream to one or more oil storage tanks.

The present invention provides a method of designing a process for providing compressed VOC as a source of blanket gas in an oil storage tank, comprising the same or similar steps as described herein.

The designing methods as discussed herein may incorporate computer aided processes for incorporating the relevant operational equipment and controls into the overall vessel construction and may incorporate relevant cost, capacity of operation parameters into the methodology and design. The methods described herein may be encoded onto media that is suitable for being read and processed on a computer. For example, code to carry out the methods described herein may be encoded onto a magnetic or optical media which can be read by and copied to a personal or mainframe computer. The methods may then be carried out by a design engineer using such a personal or mainframe computer.

### DESCRIPTION OF THE DRAWING

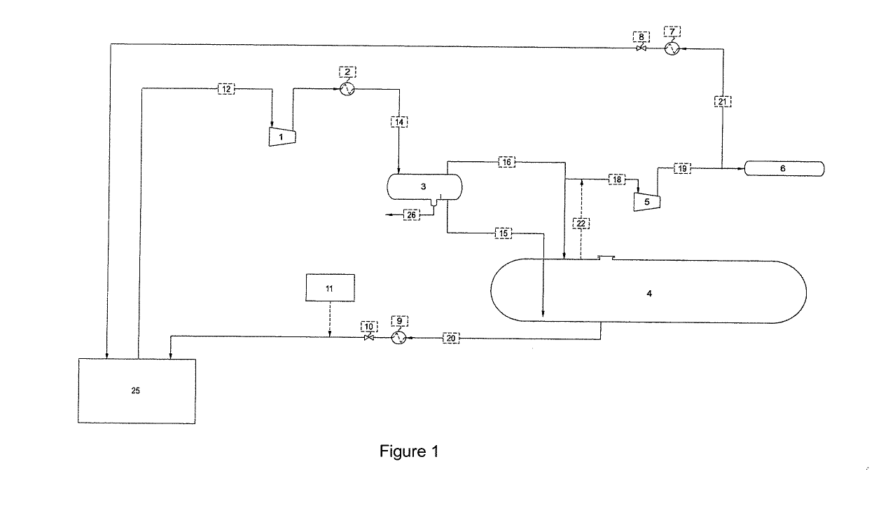

The invention can be better understood with reference to the following detailed description together with the appended illustrative drawing, FIG. 1, which depicts a schematic diagram of an example of the process of this invention.

The present invention is useable with any suitable oil storage tank, which includes cargo tanks of vessels such as crude oil carriers, shuttle carriers, etc.; oil storage tanks on offshore installations such as oil platforms, floating storage and offloading (FSO) units, floating production storage and offloading (FPSO) units; or with land-based oil processing facilities.

Crude oil tankers can range from having only one oil tank, to having a multiple of oil storage tanks.

The term ‘oil storage tank’ as used herein may relate to more than oil storage tank, and the present invention is not limited to the number or nature of the or each oil tank, or its location.

The term volatile organic compounds or VOC is known in the art, and generally comprises at least two or more of the group comprising: methane, ethane, propane, isobutane, butane, isopentane, pentane, hexane, heptane, octane, and other hydrocarbons that are naturally released by a crude oil.

The term ‘liquefied volatile organic compounds’ or LVOC comprises those VOC which can be liquefied by pressurisation above 5 barg, for example in the range 10-25 barg, and cooling below 40° C., such as in the range 5-37° C., to provide a condensation or condensed liquid, which can be stored under the conditions of 10-25 barg at ambient temperature.

The term ‘compressed volatile organic compound’ or ‘compressed VOC’ comprises those VOC which are not LVOC, such as those VOCs which cannot be liquefied by the pressurisation and cooling steps carried out on VOC recovered from an oil storage tank to provide LVOC. For example, the compressed VOC may be those VOC which remain uncondensed by pressurisation above 5 barg and cooling below 40° C.

Referring to FIG. 1, there is shown an oil storage tank 25. When the oil storage tank 25 (on land, on a ship, or an offshore installation) is loaded with crude oil, the vapour in the tank is displaced from the tank 25. Depending on initial conditions in the tank (such as pressure, temperature, and vapour composition), additional vapour may also be generated. This combined displaced and additional generated vapour is removed from the oil storage tank 25 in order to keep the storage tank pressure low.

This combined vapour is typically a mixture of inert gas and volatile organic compounds (hereinafter ‘VOC’), optionally with some water vapour. Most VOC are created when the tank is loaded, because the loading displaces a large volume of gas, and in the absence of a hydrocarbon-rich blanket, generates even more.

The combined vapour is removed via a pipeline 12 in order to maintain low pressure in oil storage tank 25. The combined vapour is compressed by one or more gas compressors 1 to a pressure such as 25 barg.

The compressed vapour is then cooled in a heat exchanger 2, which can be provided with a coolant such as seawater, where LVOC is generated by condensation. Depending on the composition of the vapour in pipeline 12, some liquid water may also be generated.

However, depending up on the conditions of the pressurisation and cooling, there is commonly a portion of the VOC which remains uncondensed, and which therefore remains as an uncondensed vapour.

The LVOC, any water, and uncondensed vapour can all be passed via a pipeline 14 to a suitable separator, such as a three-phase separator 3. In the separator 3, water can be removed through a first outlet and sent elsewhere via pipeline 26. The LVOC is passed from another lower outlet of the separator 3 and via another pipeline 15 to a suitable LVOC storage tank 4.

The uncondensed vapour can be passed out of an upper outlet of the separator 3 and passed via a pipeline 18 to a compressor 5, in which it is compressed to a higher pressure (typically greater than 100 barg or 200 barg, such as 250 barg) to produce a compressed VOC stream.

Optionally, a portion of the uncondensed vapour can be passed out of the separator 3 and directly into the LVOC storage tank 4.

Also optionally, a portion of uncondensed vapour in the LVOC storage tank 4 can be sent to the compressor 5 from the LVOC storage tank 4 via a pipeline 22.

The compressed VOC stream can be sent via a pipeline 19 to a compressed VOC storage tank 6. The compressed VOC comprises the lighter components (typically predominantly nitrogen, methane, and ethane) that cannot be liquefied under the same conditions as LVOC.

Thus, during loading of the oil storage tank 25, LVOC and compressed VOC are being created. This generally ceases once the oil loading into the oil storage tank 25 is complete. This provides a supply of compressed VOC ready to use in the compressed VOC tank 6, and a supply of LVOC in the LVOC storage tank 4.

As a separate stage, typically some time later, the oil storage tank 25 undergoes a partial of complete unloading or emptying operation. At that time the compressed VOC, and optionally any required LVOC, can be used to supply the new blanket gas in the oil storage tank 25.

In one way, the present invention is a two-step process, the first step being generation of compressed VOC and LVOC during loading of an oil storage tank, and the second step being use of the compressed VOC as a source of blanket gas to be supplied to the oil storage tank during unloading of the oil storage tank. This process can be in association with the use of any LVOC also required as blanket gas.

When required for use as a source of blanket gas, the compressed VOC in the compressed VOC storage tank 6 can be provided via a pipeline 21 to a VOC heater 7, and to a pressure let-down system or reducer 8, in order to generate a lower-pressure stream that can be provided into the oil storage tank 25 as blanket gas, to assist or maintain positive pressure in the oil storage tank 25.

Alternatively, the compressed VOC stream in the pipeline 21 can first undergo pressure let-down or reduction, and then heating.

As the blanket gas provided from the compressed VOC stream comprises a high proportion of light hydrocarbon components, it will generally be less absorbed into oil subsequently loaded into the oil storage tank 25. This may partly depend upon the constituency of the oil that was in the relevant storage tank creating the VOC, and the constituency of the oil next being loaded into the relevant storage tank, but assumes any difference in the constituency to be of sufficiently small variance.

If any further blanket gas is required in the oil storage tank 25 after using the compressed VOC as the initial source of blanket gas, a supply of LVOC from the LVOC storage tank 4 can be vaporised and sent via a pipeline 20, to be heated or vaporised in a LVOC heater 9, followed by a pressure let-down 10, in order to provide further blanket gas for the oil storage tank 25.

Any further deficit of blanket gas in or expected in the oil storage tank 25 can be provided by the introduction of an amount of inert gas 11 (optionally from a nitrogen generator, possibly from a combustion-type inert gas generator), which can be introduced into the latter part of pipeline 20 (or into the latter part of the decompressed VOC pipeline) to provide the balance.

By introducing the light hydrocarbon components provided by the compressed VOC first in the oil storage tank 25, followed only later by any required supply of LVOC, the composition of gas in the vapour space of the oil storage tank 25 is maintained at its lightest hydrocarbon definition possible, thereby minimising or preventing reabsorption of the blanket gas into the crude oil. In recovering the light components as compressed VOC, and in the sequencing as proposed above (compressed VOC followed by LVOC), VOC generation in the tank is reduced, subsequent vapour recovery is easier, inert gas usage is minimised, and venting of vapour from the crude oil tank is prevented.

The present invention uses compressed VOC as a source of blanket gas, optionally with a further source of blanket gas from LVOC. Both the compressed VOC and LVOC can be sourced from recovered VOC from the same oil storage tank or tanks requiring the blanket gas, optionally stored in suitable storage tanks, in-between loading and unloading of the oil storage tank(s) with oil or oil product.

The present invention is designed to achieve little or no generation of VOC or (re)-absorption of VOC from the blanket gas into the oil during its unloading from the oil storage tank(s). For example, the present invention is able to achieve the steps of:
filling one or more oil storage tanks with a nominal value such as 120,000 m³ of crude oil,
thereby displacing 120,000 m³ of vapour from the oil storage tank(s);
entirely capturing such vapour as compressed VOC and optionally some LVOC, and then later
discharging the 120,000 m³ of oil, and
wholly or substantially replacing that volume with the same 120,000 m³ of vapour sourced from the compressed VOC and optional LVOC that were created.

The present invention is also able to prevent or substantially reduce reabsorption of captured VOC into stored oil. This means less (and possibly no) addition of any extra inert gas during the oil discharge, and the next oil loading into the oil storage tank starting with a tank atmosphere that is very high in hydrocarbon content, thereby preventing formation of additional VOC during the next oil loading.

1. Compressed volatile organic compounds (VOC) as a source of blanket gas for use in an oil storage tank.

2. Compressed VOC as claimed in claim 1 wherein the compressed VOC is wholly or substantially provided from a source of VOC provided by one or more oil storage tanks.

3. Compressed VOC as claimed in claim 2 wherein the compressed VOC is wholly or substantially provided from a source of VOC provided by one or more oil storage tanks using the blanket gas.

4. Compressed VOC as claimed in any one of the preceding claims wherein the compressed VOC wholly or substantially comprises uncondensed VOC provided by one or more oil storage tanks.

5. Compressed VOC as claimed in any one of the preceding claims wherein the compressed VOC partly comprises vapour of condensed VOC provided by one or more oil storage tanks.

6. Compressed VOC as claimed in any one of the preceding claims wherein the compressed VOC is from a source of condensed and separated VOC provided by one or oil storage tanks.

7. Compressed VOC as claimed in claim 6, wherein the compressed VOC is from a source of condensed and separated VOC provided by one or oil storage tanks using the blanket gas.

8. Compressed VOC as claimed in any one of the preceding claims wherein the compressed VOC is stored in a compressed VOC tank.

9. Compressed VOC as claimed in any one of the preceding claims wherein the oil storage tank is one of the group comprising: a cargo tank of a sea vessel including a crude oil carrier; an oil storage tank on an offshore installation including an oil platform, a floating storage and offloading (FSO) unit, a floating production storage and offloading (FPSO) unit, or an oil storage tank in land-based oil processing facility.

10. Use of compressed volatile organic compounds (VOC) as a source of blanket gas in an oil storage tank.

11. Use of compressed VOC as claimed in claim 10 wherein the compressed VOC is defined in any one of claims 2 to 9.

12. Blanket gas for use in an oil storage tank partly, substantially of wholly based on compressed volatile organic compounds (VOC).

13. Blanket gas as claimed in claim 12, partly, substantially of wholly based on compressed VOC and liquefied volatile organic compounds (LVOC).

14. Blanket gas as claimed in claim 12 or claim 13, wherein the compressed VOC is defined in any one of claims 2 to 9.

15. A method of providing blanket gas for use in one or more oil storage tanks comprising at least the steps of;
(a) providing a supply of compressed volatile organic compounds (VOC);
(b) heating the compressed VOC;
(c) reducing the pressure of the compressed VOC; and
(d) providing the decompressed VOC to the one or more oil storage tanks.

16. A method as claimed in claim 15 wherein the compressed VOC is supplied from a source separate from the one or more oil tanks.

17. A method as claimed in claim 15 or claim 16 wherein the method further comprises the steps of:
(e) recovering VOC from one or more oil storage tanks as a recovered VOC stream;
(f) compressing and separating the recovered VOC stream to provide at least a liquefied volatile organic compounds (LVOC) stream and an uncondensed VOC stream;
(g) compressing the uncondensed VOC stream to provide the compressed VOC.

18. A method as claimed in claim 17 wherein the method further comprises the step of recovering the VOC from the same one or more oil storage tanks subsequently provided with the decompressed VOC.

19. A method as claimed in any one of claims 17-18 wherein the method comprises compressing the recovered VOC stream to provide at least a LVOC stream and a uncondensed VOC stream at pressure above 5 barg.

20. Apparatus for providing blanket gas for use in an oil storage tank, the apparatus comprising a supply of compressed volatile organic compounds (VOC), a heater to heat the compressed VOC, and a pressure-reducing system to reduce the pressure of the compressed VOC.

21. A method of recovering and using volatile organic compounds (VOC) from one or more oil storage tanks comprising at least the steps of;
(a) recovering VOC from the one or more oil storage tanks as a recovered VOC stream;
(b) compressing the recovered VOC stream to provide a compressed recovered VOC stream;
(c) separating the compressed recovered VOC stream to provide at least a liquefied volatile organic compounds (LVOC) stream and an uncondensed VOC stream;
(d) compressing the uncondensed VOC stream to provide a compressed VOC stream;
(e) heating at least a portion of the compressed VOC stream to provide a warmer compressed VOC stream;
(f) reducing the pressure of the warmer compressed VOC to provide a decompressed VOC stream; and
(g) providing the decompressed VOC stream as blanket gas to one or more oil storage tanks.

22. A method as claimed in claim 21 wherein the recovery of VOC from the one or more oil storage tanks occurs when the oil storage tank is being loaded with oil, and the providing of the decompressed VOC stream as a blanket gas occurs when the oil storage tank is being emptied of the oil.

23. A method as claimed in claim 21 or claim 22 wherein the method further comprises the steps of heating at least a portion of the LVOC stream to provide a warmer LVOC stream, reducing the pressure of the warmer LVOC stream to provide a decompressed VOC stream, and providing the decompressed VOC stream as additional blanket gas to one or more oil storage tanks.

24. Apparatus for recovering and using volatile organic compounds (VOC) from one or more oil storage tanks comprising at least;
(a) one or more pipelines able to recover VOC from the one or more oil storage tanks as a recovered VOC stream;
(b) one or more first compressors able to compress the recovered VOC stream to provide a compressed recovered VOC stream;
(c) one or more separators able to separate the compressed recovered VOC stream to provide at least a liquefied volatile organic compounds (LVOC) stream and an uncondensed VOC stream;
(d) one or more second compressors able to compress the uncondensed VOC stream to provide a compressed VOC stream;
(e) one or more heaters able to heat at least a portion of the compressed VOC stream to provide a warmer compressed VOC stream;
(f) one or more reducers able to reduce the pressure of the warmer compressed VOC to provide a decompressed VOC stream; and
(g) one or more pipelines able to provide the decompressed VOC stream as blanket gas to one or more oil storage tanks.

25. Apparatus as claimed in claim 24 further comprising one or more storage tanks able to store the compressed VOC stream prior to step (e).

26. Apparatus as claimed in claim 24 or claim 25 further comprising one or more storage tanks able to store the LVOC stream.

27. Apparatus as claimed in any one of claims 24 to 26 further comprising one or more one or more heaters able to heat at least a portion of the LVOC stream to provide a warmer LVOC stream, and one or more reducers able to reduce the pressure of the warmer LVOC to provide a decompressed VOC stream, and one or more pipelines able to provide the decompressed VOC stream as additional blanket gas to the one or more oil storage tanks.

28. Apparatus as claimed in any one of claims 24 to 27 arranged on a sea vessel, on an oil platform, on a floating storage and offloading (FSO) unit, or on floating production storage and offloading (FPSO) unit.

29. A method of loading and unloading an oil or oil product, including crude oil, into and from one or more oil storage tanks comprising at least the steps of;
(a) loading the oil or oil product into the one or more oil storage tanks;
(b) recovering volatile organic compounds (VOC) from the one or more oil storage tanks as a recovered VOC stream;
(c) compressing the recovered VOC stream to provide a compressed recovered VOC stream;
(d) separating the compressed recovered VOC stream to provide at least a liquefied volatile organic compounds (LVOC) stream and an uncondensed VOC stream;
(e) storing the LVOC stream in one or more LVOC storage tanks;
(f) compressing the uncondensed VOC stream to provide a compressed VOC stream;
(g) storing the compressed VOC in one or more compressed VOC storage tanks;
(h) unloading the oil or oil product from the one or more oil storage tanks
(i) heating at least a portion of the compressed VOC stream to provide a warmer compressed VOC stream;
(j) reducing the pressure of the warmer compressed VOC to provide a decompressed VOC stream; and
(k) providing the decompressed VOC stream as blanket gas to one or more oil storage tanks.

30. A method as claimed in claim 29 further comprising the steps of heating at least a portion of the LVOC stream to provide a warmer LVOC stream, reducing the pressure of the warmer LVOC stream to provide a decompressed VOC stream, and providing the decompressed VOC stream as additional blanket gas to the one or more oil storage tanks.

31. A method as claimed in claim 29 or claim 30 wherein the oil storage tank is one of the group comprising: a cargo tank of a sea vessel including a crude oil carrier; an oil storage tank on an offshore installation including an oil platform, a floating storage and offloading (FSO) unit, a floating production storage and offloading (FPSO) unit, or an oil storage tank in land-based oil processing facility.

32. A method of reducing or preventing the reabsorption of blanket gas into oil in an oil storage tank, comprising the step of using compressed volatile organic compounds (VOC) as a source of the blanket gas in the oil storage tank.

33. A method of reducing the creation of volatile organic compounds (VOC) from oil in an oil storage tank, comprising the step of using compressed VOC as a source of the blanket gas in the oil storage tank.

34. A method of reducing the use of inert gas as a blanket gas in an oil storage tank, comprising the step of using compressed volatile organic compounds (VOC) as a source of the blanket gas in the oil storage tank.

35. A volatile organic compounds (VOC) recovery plant including the use of compressed VOC as a source of blanket gas in an oil storage tank.

36. A method of integratively designing a vessel having at least one oil storage tank, comprising the steps of:
selecting one or more oil tanks for use within vessel;
selecting a first pipeline for recovering volatile organic compounds (VOC) from the one or more oil storage tanks as a recovered VOC stream;
selecting one or more compressors for compressing the recovered VOC stream to provide a compressed recovered VOC stream;
selecting a separator for separating the compressed recovered VOC stream to provide at least a liquefied volatile organic compounds (LVOC) stream and an uncondensed VOC stream
selecting one or more compressors for compressing the uncondensed VOC stream to provide a compressed VOC stream;
selecting one or more heaters for heating at least a portion of the compressed VOC stream to provide a warmer compressed VOC stream;
selecting one or more pressure reducers to reduce the pressure of the warmer compressed VOC to provide a decompressed VOC stream; and
selecting a second pipeline to provide the decompressed VOC stream to one or more oil storage tanks.

37. A method of designing a process for providing compressed volatile organic compounds (VOC) as a source of blanket gas in an oil storage tank, comprising the steps as defined in claim 36.
